(19) United States
(12) Patent Application Publication
(10) Pub. No.: US 2008/0196240 A1
(43) Pub. Date: Aug. 21, 2008

(54) Glue-free packaging process for slim batteries and products thereof

(76) Inventors: Yung-Huang Lin, Hsinchu Hsien (TW); Chung-Da Yang, Hsinchu Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/806,085

(22) Filed: May 30, 2007

(30) Foreign Application Priority Data
Feb. 15, 2007 (TW) 96105685

(51) Int. Cl. H01M 4/82

(52) U.S. Cl. 29/623.2

(57) ABSTRACT

A glue-free packaging process for slim batteries includes the following steps: providing a frame with side walls. There are embedded slots on the side walls. On one of the side walls, there is a blocking wall and a wedged hook. A first board is provided. First embedded flakes extend from the first board. The first embedded flakes are embedded in the embedded slots and are connected by supersonic so that the first board is fastened onto bottom of the frame. A battery module is provided. The wedged hook is wedged with the top of the circuit board. A second board is provided. Second embedded flakes extend from the second board. The second embedded flakes are embedded in the embedded slots and are connected together by supersonic so that the second board is fastened onto the top of the frame.

### BACKGROUND OF THE INVENTION

1. Field of the Invention

The present invention relates to a glue-free packaging process for slim batteries and products thereof. In particular, this invention relates to a glue-free packaging process and a product that is applied to a slim battery and produces an excellent packaging effect.

2. Description of the Related Art

Batteries used for multi-media electronic devices, such as digital still cameras, cell phones, and PDAs, usually receive the battery module in a housing that is then wrapped with a layer of label. The label wraps the housing to prevent the housing from becoming loose. Without the label, the battery module is easily exposed which is dangerous. It is also necessary to use glue to package the battery module.

However, the label wrapping the housing is easily aged and broken so that the housing loosens and the battery module becomes exposed. It is dangerous. Furthermore, the label increases the cost of the required materials, makes the assembling process more inconvenient, and increases the total thickness of the battery. It does not meet design trends and consumer demands for slimmer and smaller electronic devices. Packaging the battery module using the glue is also inconvenient and damages the environment.

### SUMMARY OF THE INVENTION

One particular aspect of the present invention is to provide a glue-free packaging process for slim batteries and products thereof. The packaging effect is excellent, and the amount of label is reduced. The problems of the label ageing and breaking, the housing becoming loose, and the battery module being exposed are avoided. It is safe and meets design trends and consumer demands for electronic devices. Packing the battery module without glue can meet the requirement of the environmental protection.

The glue-free packaging process for slim batteries includes the following steps. Firstly, a frame made of plastic material is provided. The frame has a plurality of side walls. On the side walls, there is a plurality of embedded slots. In the inner side of one side wall of the frame, there is a blocking wall and a wedged hook. The blocking wall and the side wall are disposed at intervals. A first board made of metal material is provided. There is a plurality of first embedded flakes that extends upwards from the surrounding edge of the first board. The first embedded flakes embedded in the embedded slots are connected together by supersonic so that the first board is fastened onto to the bottom of the frame. A battery module is provided. The battery module includes at least one battery and a circuit board. The battery is electrically connected with the circuit board. The battery and the circuit board are placed into the frame. The battery is placed on the first board. The circuit board is clipped between the blocking wall and the side wall. The wedged hook is wedged with the top of the circuit board. A second board made of metal material is provided. There is a plurality of second embedded flakes that extends downwards from the surrounding edge of the second board. The second embedded flakes are embedded in the embedded slots and are connected together by supersonic so that the second board is fastened onto the top of the frame.

The present invention also provides a glue-free packaging product for slim batteries by using the glue-free packaging process for slim batteries.

The present invention has the following characteristics. The frame, the first board, and the second board are connected together by an embedding method and supersonic. The packaging process is simple, and has an excellent packaging effect. The label is not required again. The cost of packaging the slim batteries is reduced. The problems of the label ageing and breaking, the housing becoming loose, and the battery module being exposed are avoided. It is safe.

Furthermore, because of the frame, the first board, and the second board are connected together by supersonic, the total thickness of the frame, the first board, and the second board are reduced so that the thickness of the battery is lowered. It meets the requirements of the electronic devices being slim and small.

There are blocking walls and wedged hooks on the frame made of plastic material. By utilizing the characteristics of plastic, the battery module and the circuit board are fastened. Glue is not needed to package the battery module. The packaging process is simple, and meets the requirements of environment protection.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a flow chart of the glue-free packaging process for slim batteries of the present invention;

FIG. 2 is an exploded perspective view of the glue-free packaging product for slim batteries of the present invention;

FIG. 3 is another exploded perspective view of the glue-free packaging product for slim batteries of the present invention;

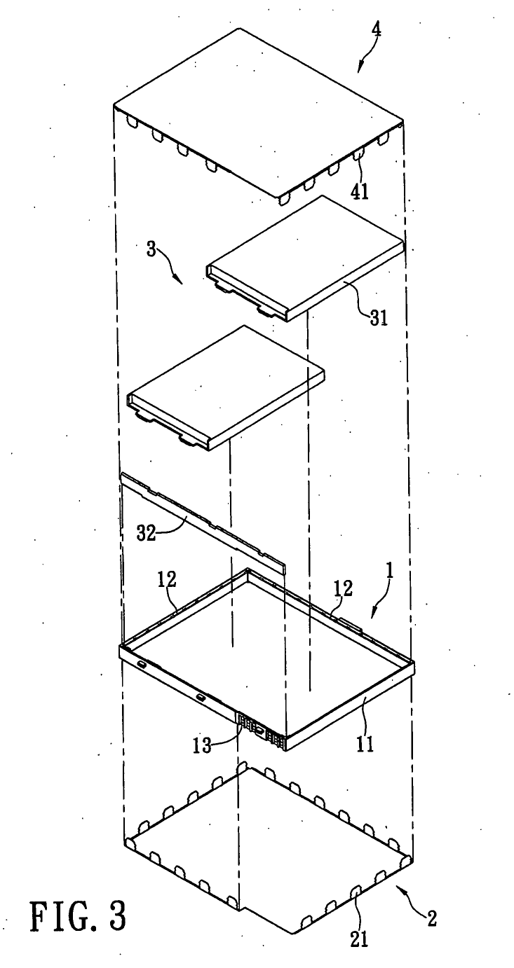

FIG. 4 is a perspective view of the glue-free packaging product for slim batteries of the present invention;

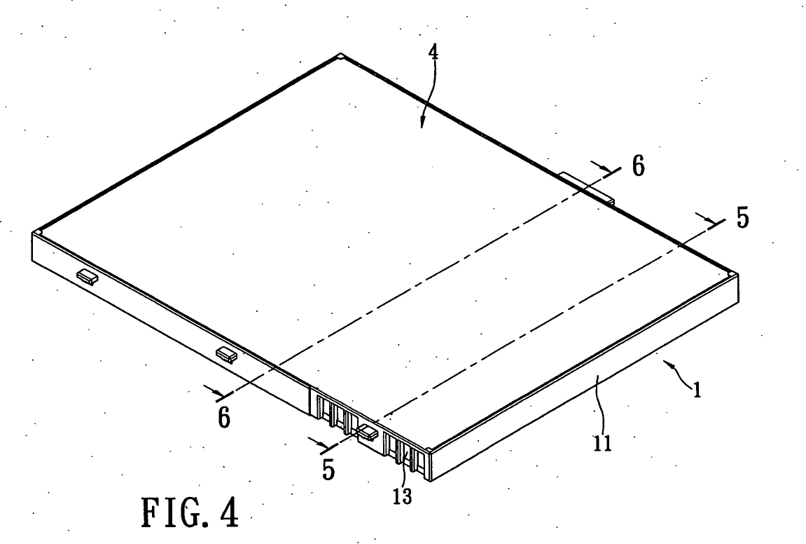

FIG. 5 is a cross-sectional view of the cross-section 5-5 in FIG.4;

FIG. 6 is a cross-sectional view of the cross-section 6-6 in FIG.4;

FIG. 7 is a detailed diagram of part A in FIG.5;

FIG. 8 is a detailed diagram of part B in FIG.6;

FIG. 9 is a perspective view of the frame of the present invention; and

FIG. 10 is another perspective view of the frame of the present invention.

### DETAILED DESCRIPTION OF THE PREFERRED EMBODIMENTS

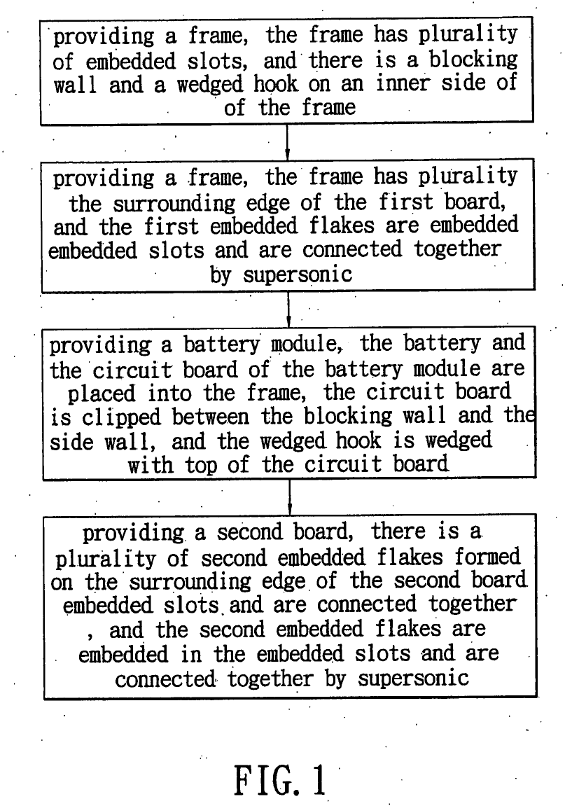

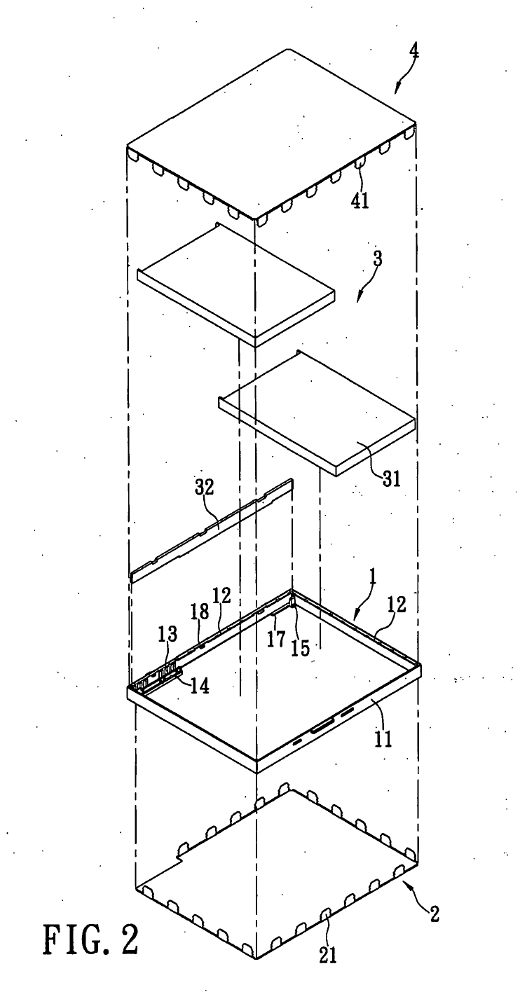

Reference is made to FIG. 1. The present invention provides a glue-free packaging process for slim batteries. The slim batteries can be used for the multi-media electronic devices, such as digital still cameras, cell phones, and PDAs, The process includes the following steps as described below (please also refer to FIGS. 2˜4).

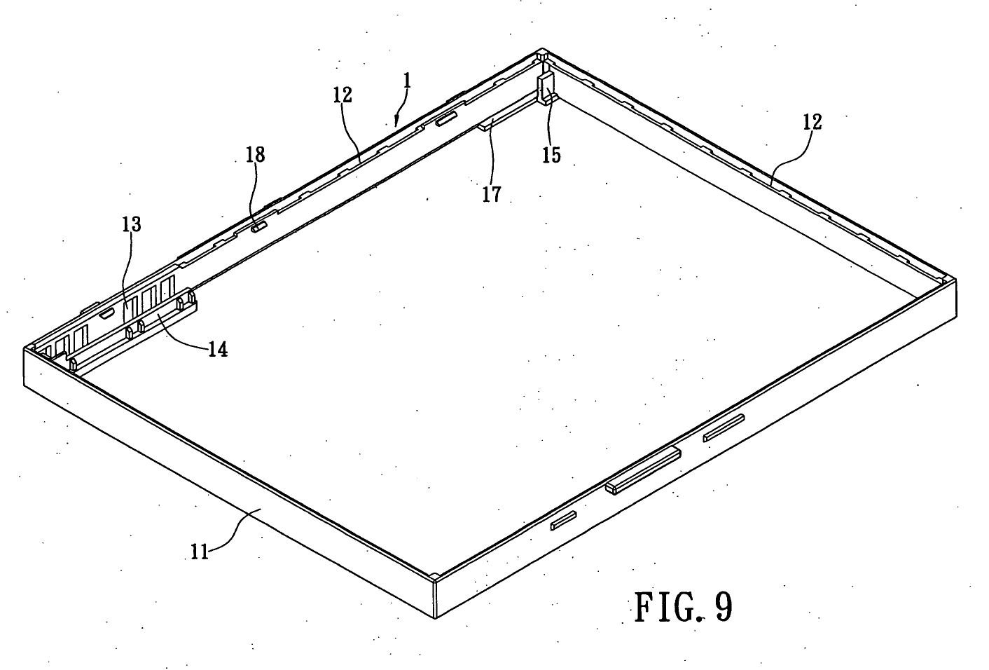

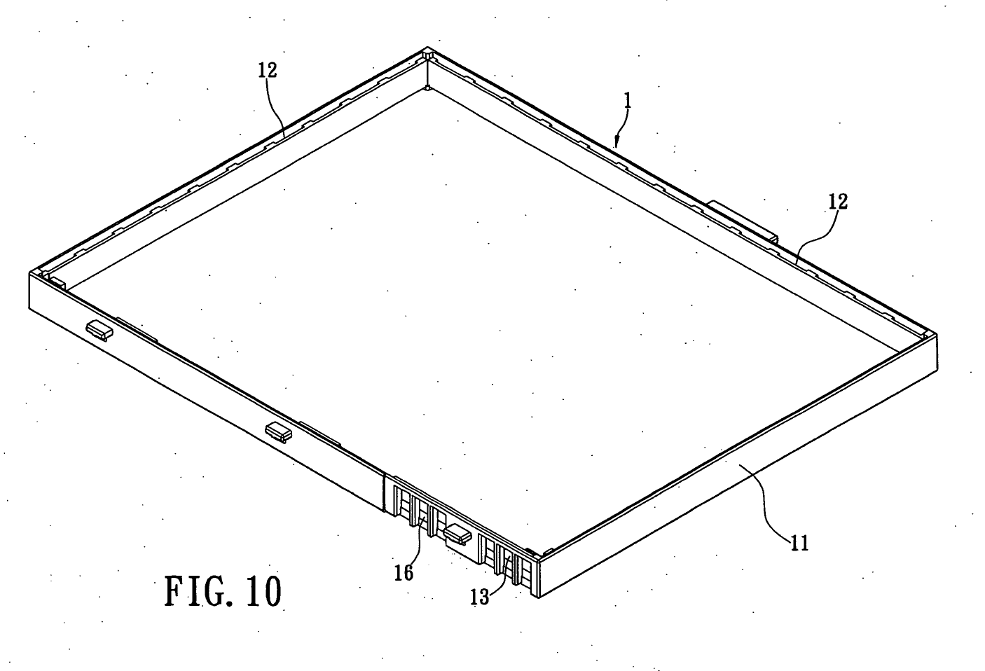

Firstly, a frame 1 made of plastic material is provided. The frame 1 is a rectangular frame and includes four side walls 11 (please refer to FIGS. 9 and 10). On the side walls 11, there is a plurality of embedded slots 12. The embedded slots 12 are disposed on the four side walls 11 at intervals. The embedded slots 12 pass through the top and the bottom of the side walls 11. On one side wall 11 of the frame 1, there is a plurality of opening holes 13. The opening holes 13 pass through the inner side and the outer side of the frame 1 so that the electric connecting points of the battery module in the frame 1 are exposed. There is a first blocking wall 14 and a second blocking wall 15 that is located on the inner side of the side wall 11, has the opening holes 13 and is close to the two ends of the side wall 11. The first blocking wall 14 and the second blocking wall 15 have a proper distance with the side wall 11. There are carrying boards 16 and 17 between the bottom of the blocking walls 14, 15 and side wall 11. There is a plurality of wedged hooks 18 located on the inner side of the side wall 11 having the opening holes 13 and is close to the top of the side wall 11 and disposed at intervals. The first blocking wall 14, the second blocking wall 15, and the wedged hook 18 form a wedged structure.

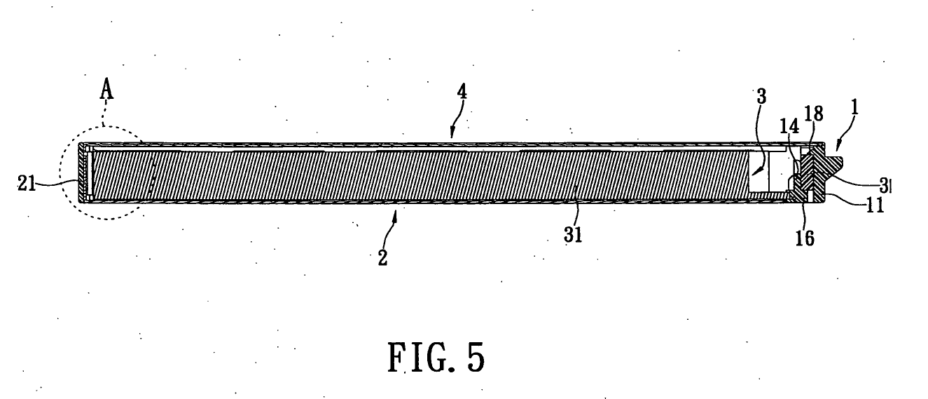

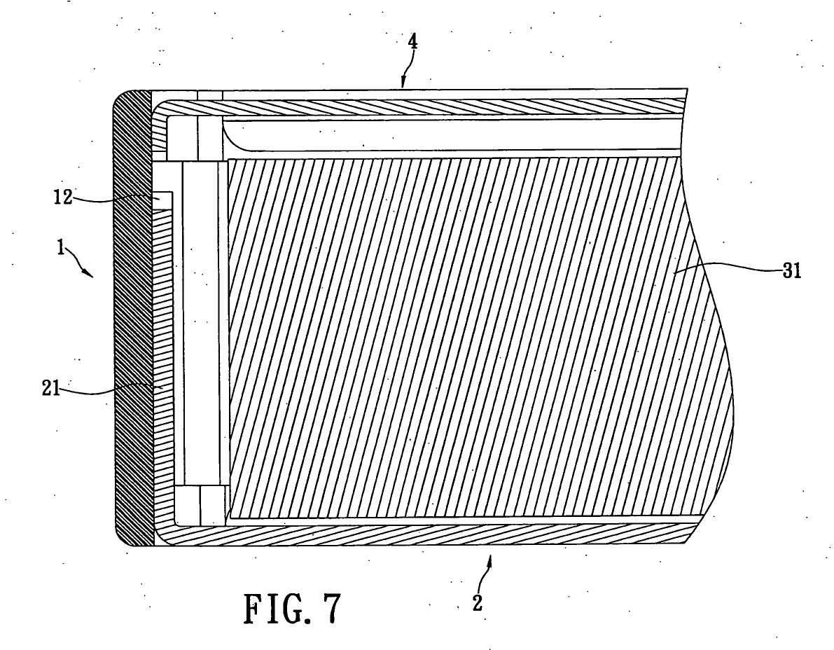

A first board 2 made of metal material, such as stainless steel, is provided. The first board 2 is a rectangular board and its shape corresponds to the shape of the frame 1. The thickness of the first board 2 is between 0.1 mm and 0.15 mm. There is a plurality of first embedded flakes 21 that extend upwards from the surrounding edge of the first board 2. The first embedded flakes 21 correspond to the embedded slots 12 on the frame 1. On two sides of the first embedded flakes 21, there are tooth-shaped structures that can interfere with and fit into the embedded slots 12. The first embedded flakes 21 are embedded with the embedded slots 12 (refer to FIGS. 5 and 7) and are connected together by supersonic so that the first board 2 is fastened onto the bottom of the frame 1.

A battery module 3 is provided. The battery module 3 includes at least one battery 31 and a circuit board 32. In this embodiment, there are two batteries 31. The two batteries 31 are electrically connected with the circuit board 32 via Ni-metal flakes and bus wires (not shown in the figure). The two batteries 31 and the circuit board 32 are placed into the frame 1. The surrounding edge of the two batteries 31 pushes and contacts the inner side of the frame 1 so that the two batteries 31 are wedged and placed in the frame 1. The two batteries 31 are placed on the first board 2. The circuit board 32 is placed on two carrying boards 16, 17. The circuit board 32 is clipped between the first blocking wall 14, the second blocking wall 15, and the side wall 11 so that it fits tightly (refer to FIG. 5). The wedged hooks are wedged with the top of the circuit board 32. The top of the circuit board 32 is lower than the top of the frame 1 so that the circuit board 32 is not affected when the frame 1 is connected with the second board 4 by supersonic. The first blocking wall 14, the second blocking wall 15, and the side wall 11 are used for limiting the inner and outer displacements of the circuit board 32. The wedged hook 18 and the carrying boards 16, 17 are used for limiting the upward and downward displacements of the circuit board 32. The front end and the rear end of the circuit board 32 push and contact the inner side of another two side walls 11 for limiting the forward and backward displacements of the circuit board 32. Thereby, the circuit board 32 is firmly positioned in the frame 1. The circuit board 32 is also adjacent to the opening holes 13 so that the electric contacting points (not shown in the figure) of the circuit board 32 are exposed to an outside of the opening holes 13.

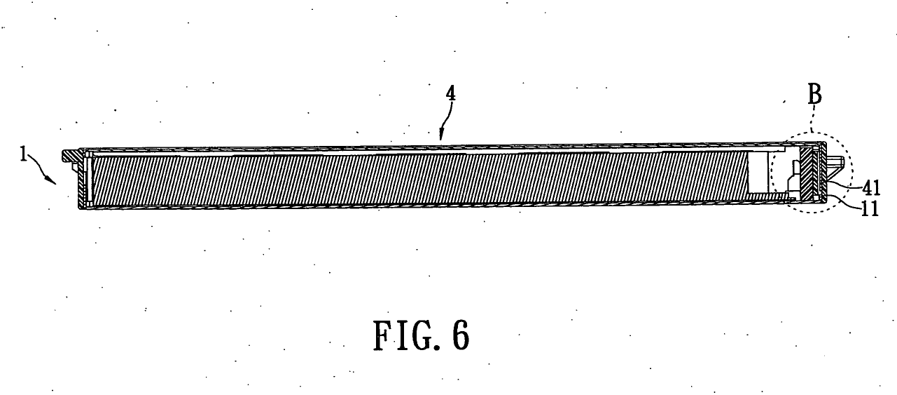

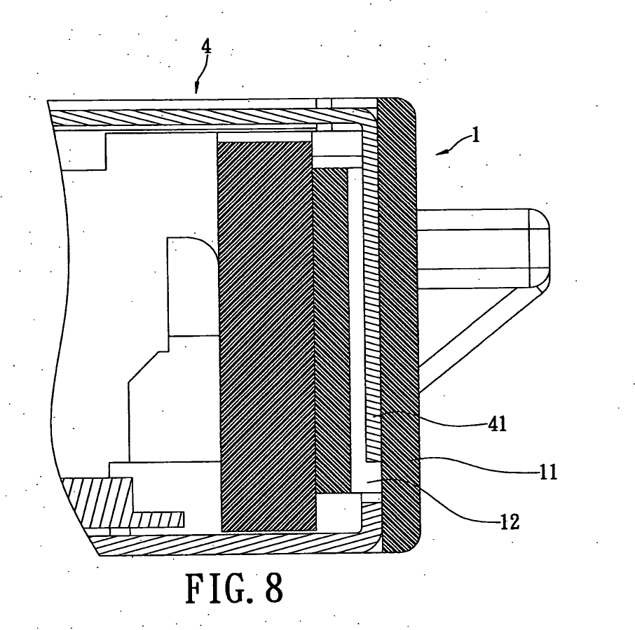

A second board 4 made of metal material, such as stainless steel, is provided. The second board 4 is a rectangular board and its shape corresponds to the shape of the frame 1. The thickness of the second board 4 is between 0.1 mm and 0.15 mm. There is a plurality of second embedded flakes 41 that extends downwards from the surrounding edge of the second board 4. The second embedded flakes 41 correspond to the embedded slots 12 on the frame 1. On two sides of the second embedded flakes 41, there are tooth-shaped structures that can interfere with and fit into the embedded slots 12. The second embedded flakes 41 are embedded with the embedded slots 12 (refer to FIGS. 6 and 8) and are connected together by supersonic so that the second board 4 is fastened onto the top of the frame 1. The second board 4 covers on the battery module 3. The frame 1, the first board 2, and the second board 4 form an integrated housing to package the battery module 3 into the housing.

In the present invention, a label is further pasted (not shown in the figure) onto the external surface of the first board 2 or the second board 4. The label is labeled with the electrical characteristics of the battery. Alternatively, the label can be omitted. The electrical characteristics of the battery can be carved on the external surface of the first board 2 or the second board 4 by laser. Thereby, the total thickness of the battery is thinner.

The frame 1, the first board 2, and the second board 4 are combined to form a firm housing by using an embedding method and supersonic. The packaging process for the battery is simple, and its packaging effect is excellent. Label is not used to package the battery module. The label is omitted or is simply pasted on part of the surface of the first board 2 or the second board 4. The cost of the product is reduced. The problems of the label ageing and breaking, the housing becoming loose, and the battery module being exposed are avoided. It is safe.

Furthermore, because the frame 1, the first board 2, and the second board 4 are connected together by supersonic, the total thickness of the frame 1, the first board 2, and the second board 4 is thinner. The thickness of the first board 2 and the second board 4 is 0.1˜0.15 mm and the label is omitted so that the thickness of the battery is lowered to meet the requirements of the electronic devices.

There are blocking walls 14, 15 and a wedged hook 18 on the frame 1 made of plastic material. By utilizing the characteristic of plastic, the battery module 3 and the circuit board 32 are fastened. Glue is not needed to package the battery module 3. The packaging process is simple, and meets the requirements of environmental protection.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A glue-free packaging process for slim batteries, comprising:
providing a frame made of plastic material, wherein the frame has a plurality of side walls, there is a plurality of embedded slots on the side walls, a blocking wall and a wedged hook are disposed on an inner side of one side wall of the frame, and the blocking wall and the side wall are disposed at intervals;
providing a first board made of metal material, wherein there is a plurality of first embedded flakes that extend upwards from the surrounding edge of the first board, and the first embedded flakes are embedded in the embedded slots and are connected together by supersonic so that the first board is fastened onto the bottom of the frame;
providing a battery module, wherein the battery module includes at least one battery and a circuit board, the battery is electrically connected with the circuit board, the battery and the circuit board are placed into the frame, the battery is placed on the first board, the circuit board is clipped between the blocking wall and the side wall, and the wedged hook is wedged with the top of the circuit board; and
providing a second board made of metal material, wherein there is a plurality of second embedded flakes that extends downwards from the surrounding edge of the second board, the second embedded flakes are embedded in the embedded slots and are connected together by supersonic so that the second board is fastened onto the top of the frame.

2. The glue-free packaging process for slim batteries as claimed in claim 1, wherein the embedded slots pass through top and bottom of the side walls.

3. The glue-free packaging process for slim batteries as claimed in claim 1, wherein there is a plurality of opening holes on one of the side walls of the frame, the opening holes pass through the inner side and the outer side of the side wall, and the circuit board is adjacent to the opening holes.

4. The glue-free packaging process for slim batteries as claimed in claim 3, wherein the blocking wall is located on the inner side of the side wall having the opening holes of the frame, and the wedged hook is located on the inner side of the side wall having the opening holes of the frame and is close to a top of the side wall.

5. The glue-free packaging process for slim batteries as claimed in claim 1, wherein there is a carrying board formed between the bottom of the blocking wall and the side wall, and the circuit is placed on the carrying board.

6. The glue-free packaging process for slim batteries as claimed in claim 1, wherein a number of the wedged hooks are greater than one.

7. The glue-free packaging process for slim batteries as claimed in claim 1, wherein a label is pasted on an external surface of the first board or the second board.

8. The glue-free packaging process for slim batteries as claimed in claim 1, wherein electric characteristics of the battery are carved on an external surface of the first board or the second board by laser.

9. The glue-free packaging process for slim batteries as claimed in claim 1, wherein two sides of the first embedded flakes have tooth-shaped structures that interface and fit with the embedded slots.

10. The glue-free packaging process for slim batteries as claimed in claim 1, wherein a surrounding edge of the battery pushes and contacts an inner side of the frame.

11. The glue-free packaging process for slim batteries as claimed in claim 1, wherein a top of the circuit board is lower than a top of the frame.

12. The glue-free packaging process for slim batteries as claimed in claim 1, wherein two ends of the circuit board push and contact inner sides of another two side walls of the frame.

13. The glue-free packaging process for slim batteries as claimed in claim 1, wherein two sides of the second embedded flakes have tooth-shaped structures that interface and fit with the embedded slots.

14. A glue-free packaging product for slim batteries is made by the glue-free packaging process for slim batteries as claimed in claim 1.

15. A glue-free packaging process for slim batteries, comprising:
providing a frame made of plastic material, wherein the frame has a plurality of side walls, there is a plurality of embedded slots on the side walls, and there is a wedged structure on an inner side of one side wall of the frame;
providing a first board made of metal material, wherein there is a plurality of first embedded flakes that extends upwards from the surrounding edge of the first board, and the first embedded flakes are embedded in the embedded slots and are connected together by supersonic so that the first board is fastened onto the bottom of the frame;
providing a battery module, wherein the battery module includes at least one battery and a circuit board, the battery is electrically connected with the circuit board, the battery and the circuit board are placed into the frame, the battery is placed on the first board, and the circuit board is wedged with and fastened onto the wedged structure; and
providing a second board made of metal material, wherein there is a plurality of second embedded flakes that extends downwards from the surrounding edge of the second board, and the second embedded flakes are embedded in the embedded slots and are connected together by supersonic so that the second board is fastened onto the top of the frame.

16. The glue-free packaging process for slim batteries as claimed in claim 15, wherein the embedded slots pass through a top and a bottom of the side walls.

17. The glue-free packaging process for slim batteries as claimed in claim 15, wherein there is a plurality of opening holes on one of the side walls of the frame, the opening holes pass through the inner side and the outer side of the side wall, and the circuit board is adjacent to the opening holes.

18. The glue-free packaging process for slim batteries as claimed in claim 15, wherein a label is pasted on an external surface of the first board or the second board.

19. The glue-free packaging process for slim batteries as claimed in claim 15, wherein electric characteristics of the battery are carved on an external surface of the first board or the second board by laser.

20. The glue-free packaging process for slim batteries as claimed in claim 15, wherein two sides of the first embedded flakes have tooth-shaped structures that interface and fit with the embedded slots.

21. The glue-free packaging process for slim batteries as claimed in claim 15, wherein a surrounding edge of the battery pushes and contacts an inner side of the frame.

22. The glue-free packaging process for slim batteries as claimed in claim 15, wherein a top of the circuit board is lower than a top of the frame.

23. The glue-free packaging process for slim batteries as claimed in claim 15, wherein two ends of the circuit board push and contact an inner side of another two side walls of the frame.

24. The glue-free packaging process for slim batteries as claimed in claim 15, wherein two sides of the second embedded flakes have tooth-shaped structures that interface and fit with the embedded slots.

25. A glue-free packaging product for slim batteries is made by the glue-free packaging process for slim batteries as claimed in claim 15.
